(19) United States
(12) Patent Application Publication
(10) Pub. No.: US 2026/0196742 A1
(43) Pub. Date: Jul. 9, 2026

(54) DIRECTION FINDING FOR OMNI-DIRECTIONAL ANTENNA SYSTEMS

(71) Applicant: DISH Wireless L.L.C., Littleton, CO (US)

(72) Inventor: In-Kyung Kim, Highlands Ranch, CO (US)

(21) Appl. No.: 19/009,213

(22) Filed: Jan. 3, 2025

(51) Int. Cl. H01Q 21/20; H01Q 21/06; H01Q 21/24

(52) U.S. Cl. CPC H01Q 21/205; H01Q 21/065; H01Q 21/245

(57) ABSTRACT

Various arrangements of an omni-directional antenna system and related methods are presented herein. Multiple antennas are used create an omni-directional antenna beam pattern in the azimuthal plane. The system can include multiple attenuators connected with some of the antennas. A signal processing system can be electrically connected with the antennas and attenuators to perform signal strength measurements with and without the attenuators enabled. Based on the measurements, a direction to UE can be determined.

### BACKGROUND

Access points (APs) can involve multiple antennas arranged in a pattern to give relatively consistent gain in an omni-directional pattern in the azimuthal plane. As such, regardless of how an AP is arranged relative to its environment, antenna gain is relatively consistent. While such an arrangement may be easy to manage and install, in a real-world environment, certain disadvantages may exist. First, it may not be possible to readily ascertain the direction to user equipment (UE) communicating with the AP. Additionally, certain directions may tend to experience higher user equipment (UE) traffic with the AP than other directions. An administrator may desire to know the direction in which UE are located. The administrator may further desire to be able to increase gain in the one or more directions where UEs tend to be located.

### SUMMARY

Various embodiments are described related to an omni-directional antenna system. In some embodiments, an omni-directional antenna system is described. The system may comprise a first plurality of antennas and a second plurality of antennas. The first plurality of antennas and the second plurality of antennas may be arranged to create an omni-directional antenna beam pattern in the azimuthal plane. The system may comprise a plurality of attenuators. Only a first subset of the first plurality of antennas may be electrically connected with the plurality of attenuators. Only a second subset of the second plurality of antennas may be electrically connected with the plurality of attenuators. The system may comprise a signal processing system electrically connected with the first plurality of antennas, the second plurality of antennas, and the plurality of attenuators. The signal processing system may be configured to perform a first set of signal strength measurements with the plurality of attenuators disabled. The signal processing system may be configured to perform a second set of signal strength measurements with one or more of the attenuators enabled. The signal processing system may be configured to determine a direction to a user equipment (UE) based on the first set of signal strength measurements and the second set of signal strength measurements.

Embodiments of such a system may include one or more of the following features: the first plurality of antennas may comprise two antennas and the second plurality of antennas may comprise two antennas. The plurality of attenuators may comprise four attenuators. Two attenuators may be connected with one antenna of the first plurality of antennas and another two attenuators may be connected with one antenna of the second plurality of antennas. The system may further comprise, for each antenna of the first plurality of antennas and the second plurality of antennas, a plurality of feeds that may allow for transmission and reception of multiple signal polarizations. The direction to the UE may be determined based on whether a defined threshold attenuation in signal strength from the UE being detected when the one or more attenuators are enabled. Each antenna of the first plurality of antennas and the second plurality of antennas may be a patch antenna. The first plurality of antennas and the second plurality of antennas may be configured to communicate using orthogonal polarizations. The omni-directional antenna system may be incorporated as part of an indoor wireless network access point such that the first plurality of antennas may be arranged on a first axis and the second plurality of antennas may be arranged on a second axis orthogonal to the first axis. The signal processing system may be further configured to perform 5G New Radio (NR) communications with the UE. The omni-directional antenna beam pattern in the azimuthal plane may include a maximum difference of −6 dB between maximum and minimum antenna system gain. The signal processing system is further configured to increase transmitted signal strength in the determined direction of the UE and decrease the transmitted signal strength in a second direction distinct from the determined direction of the UE. The signal processing system may be further configured to store an indication of a direction of the UE and a corresponding timestamp for when the direction was determined.

In some embodiments, a method for direction finding using an omni-directional antenna system is described. The method may comprise performing a first set of signal strength measurements with a plurality of attenuators disabled. The omni-directional antenna system may comprise a first plurality of antennas and a second plurality of antennas. The first plurality of antennas and the second plurality of antennas may be arranged to create an omni-directional antenna beam pattern in the azimuthal plane. Only a first subset of the first plurality of antennas may be electrically connected with the plurality of attenuators. Only a second subset of the second plurality of antennas may be electrically connected with the plurality of attenuators. The method may comprise performing a second set of signal strength measurements with one or more of the attenuators enabled. The method may comprise determining, based on the first set of signal strength measurements and the second set of signal strength measurements, a direction to a user equipment (UE).

Embodiments of such a method may include one or more of the following features: the first plurality of antennas may comprise two antennas and the second plurality of antennas may comprise two antennas. The plurality of attenuators may comprise four attenuators. Two attenuators may be connected with one antenna of the first plurality of antennas and another two attenuators may be connected with one antenna of the second plurality of antennas. The method may comprise, for each antenna of the first plurality of antennas and the second plurality of antennas, a plurality of feeds that may allow for transmission and reception of multiple signal polarizations. The direction to the UE may be determined based on whether a defined threshold attenuation in signal strength from the UE may be detected when the one or more attenuators are enabled. The first plurality of antennas and the second plurality of antennas may be configured to communicate using orthogonal polarizations. The omni-directional antenna system may be incorporated as part of an indoor wireless network access point such that the first plurality of antennas may be arranged on a first axis and the second plurality of antennas may be arranged on a second axis orthogonal to the first axis. The signal processing system may be further configured to perform 5G New Radio (NR) communications with the UE. The omni-directional antenna beam pattern in the azimuthal plane may include a maximum difference of −6 dB between maximum and minimum antenna system gain. The method may further comprise increasing transmitted signal strength in the determined direction of the UE and decrease the transmitted signal strength in a second direction distinct from the determined direction of the UE.

### BRIEF DESCRIPTION OF THE DRAWINGS

FIG. 1A illustrates an embodiment of an omni-directional antenna array of patch antennas.

FIG. 1B illustrates an embodiment of an omni-directional antenna array arranged to radiate in four directions in the azimuthal plane.

FIG. 2 illustrates an embodiment of an omni-directional antenna gain pattern.

FIG. 3 illustrates an embodiment of an omni-directional antenna system that permits direction finding of UEs.

FIG. 4 illustrates an embodiment of a method for direction finding of UE with an omni-directional antenna system.

FIG. 5 illustrates an embodiment of how angular resolution can be increased.

### DETAILED DESCRIPTION

An access point, such as an indoor small cell for 5G (or beyond) or a Wi-Fi access point, may make use of multiple directional antennas to create an omni-directional pattern with each antenna having a similar gain. Due to how such antennas can be connected with their respective amplifiers and signal combiners, it may not be possible to disambiguate the direction from which a signal from a UE originates. Arrangements detailed herein introduce additional hardware that allows for disambiguation of the direction from which a UE is communicating with the AP.

To do so, attenuators can be introduced to the front-end architecture of the omni-directional antenna system. The attenuators allow for particular antennas to be temporarily attenuated or completed disabled in order to disambiguate the direction from which a UE is transmitting wireless signals. In some embodiments, the antenna system can include a 2×2 multiple in, multiple out (MIMO) patch antenna array. Such a patch antenna array system can use orthogonal polarization to increase data throughput. Attenuators may be activated for a short period of time to ascertain the direction from which a UE is transmitting. Once the direction to the UE is ascertained, the gain of one or more particular antennas may be adjusted or a heat map of UE use may be created.

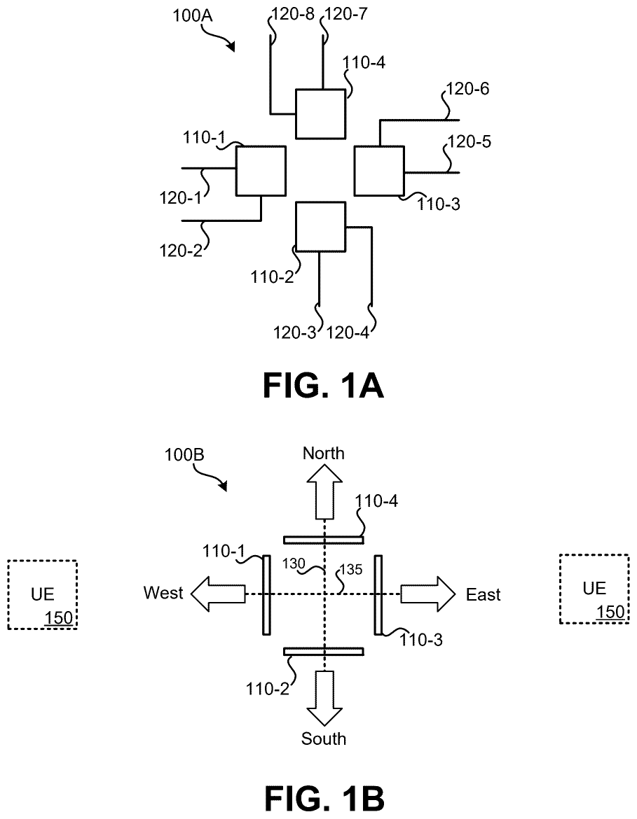

Further detail regarding such arrangements and other embodiments is provided in relation to the figures. FIG. 1 illustrates an embodiment of an omni-directional antenna array 100A (“array 100A”). In array 100A, four patch antennas 110 are present. Patch antennas, also known as microstrip antennas, are a type of radio antenna with a low profile that can be mounted on a flat surface. Patch antennas, for example, can be printed onto printed circuit boards (PCBs). Patch antennas can be used in combination with Multiple Input Multiple Output (MIMO) technology. MIMO technology enhances communication performance by using multiple antennas at both the transmitter and receiver ends to improve data throughput and link reliability. For example, in a 2×2 MIMO arrangement, two antennas are used at the transmit side and two antennas are used at the receive side. When combined, patch antennas and MIMO technology can significantly boost wireless system performance, providing higher data rates, better signal quality, and increased capacity without requiring additional spectrum.

In order to achieve MIMO, such as in a 2×2 MIMO arrangement, multiple signal polarizations can be used to allow multiple distinct signals to be transmitted simultaneously. As an example, the four patch antennas 110 may function as a single omni-directional antenna system transmitting and receiving wireless signals using two different polarizations, such as vertical and horizontal polarization. Using two polarizations effectively allows one antenna (or one antenna system) to function as two antennas for use in a MIMO system.

In array 100A, each patch antenna is connected with two feeds. For example, patch antenna 110-1 is connected with microstrip feed 120-1 and microstrip feed 120-2. To transmit two signal simultaneously, a first signal may be transmitted to antennas 110 via feeds 120-1, 120-3, 120-5, and 120-7 and a second signal may be transmitted to antennas 110 via feeds 120-2, 120-4, 120-6, and 120-8.

While patch antennas and linear polarization is used in the above detailed embodiment of array 100A, in other embodiments, greater numbers of antennas may be used, which may or may not be patch antennas. Further, other forms of polarization can be used, such as clockwise and counterclockwise polarization.

Such an array of antennas may be used as part of an access point, such as an indoor access point. An indoor access point may benefit from being omni-directional (e.g., in the azimuthal plane), thus allowing for uniform coverage with UE throughout a region around the AP. Such wireless access points may be used for wireless local area networks and cellular networks. For example, technologies such as WiFi, LTE, and 5G may be used.

In order to provide near uniform coverage in the azimuthal plane, each of patch antennas 110 may be pointed in a different direction in the azimuthal plane. FIG. 1B illustrates an embodiment 100B of the omni-directional antenna array 100A of FIG. 1 arranged to radiate in four directions in the azimuthal plane. Each of antennas 110 is pointed in a different direction in order to provide a near omni-directional beam pattern for the antenna system as a whole. In this four antenna system, antennas 110-1 and 110-3 may be arranged on a first axis 135; antennas 110-2 and 110-4 may be arranged on a second axis that is orthogonal to the first axis and within the azimuthal plane. For simplicity, the directions in which antennas 110 are facing can be referred to as north, east, south and west.

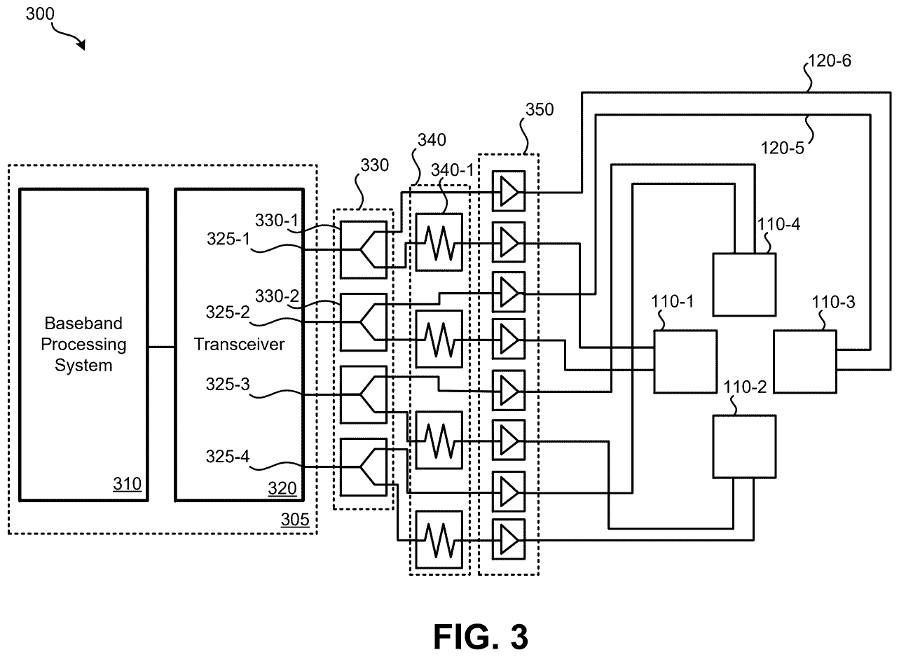

In FIG. 1B, UE 150 is shown approximately on axis 135. In some antenna systems, in which multiple antennas are connected with the same transceiver inputs/outputs, such as detailed in relation to FIG. 3, determining a direction to UE 150 can lead to ambiguous results, such as whether UE 150 is located east or west of the antenna array. For example, it may not be possible to affirmatively ascertain the direction to UE 150 being west of antenna 110-1 or east of antenna 110-3. As such, in this example, the location of UE 150 is shown as ambiguous by showing UE 150 is multiple directions from the antenna array. A similar ambiguous situation may exists with UE located north or south of the antenna array. Further, such UEs need not be located directly along axis 130 or axis 135—similar ambiguity can result for UEs located at arbitrary directions, such as northeast and southwest of the antenna array. The omni-directional antenna arrangement of FIG. 3 addresses such ambiguity.

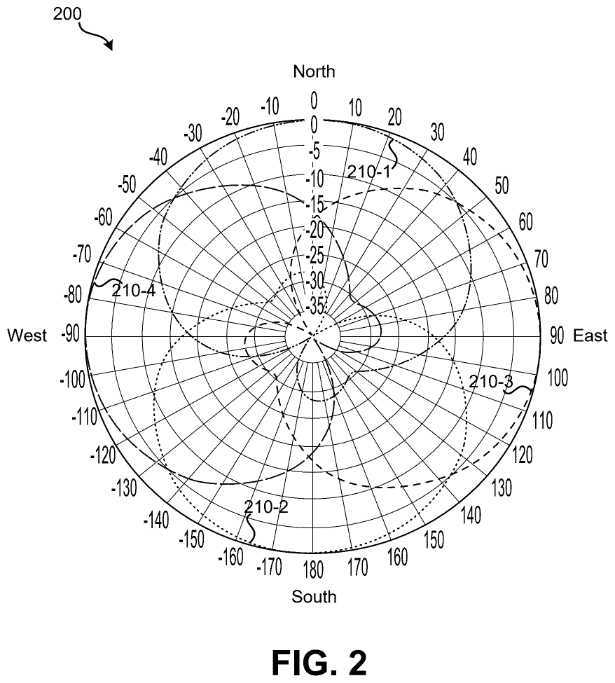

FIG. 2 illustrates an embodiment of an omni-directional antenna gain pattern. Four patch antennas, arranged as detailed in relation to FIGS. 1A and 1B, can have an antenna gain pattern in the azimuthal plane as shown in diagram 200. While antenna gain of the array 100A is not perfectly omni-directional, having omni-directional gain can be defined as having no more than a 10, 6, or 6 dB difference between maximum and minimum antenna gain in the azimuthal plane. For example, at 45°, the gain is 6 dB lower than at 90°. In other embodiments, other similar variances in gain between minimum and maximum may be present.

FIG. 3 illustrates an embodiment of an omni-directional antenna system 300 (“system 300”) that permits direction finding of UEs. System 300 can include: baseband processing system 310; transceiver 320; combiner/splitters 330; attenuators 340; amplifiers 350; antenna feeds 120; and antennas 110. Antennas 110 may be arranged as detailed in relation to FIG. 1B in order to create an omni-directional antenna gain pattern, such as exemplified in FIG. 2. Each of antennas 110 may be connected with two antenna feeds that permit transmission and reception of two orthogonally polarized signals simultaneously.

In system 300, signal processing system 305 is present, which includes baseband processing system 310 and transceiver 320. Baseband processing system 310 refers to one or more electronic components or software implemented on underlying general-purpose hardware that handles and manipulates raw, unmodulated electrical signals at their original frequency range, before any modulation or conversion to higher frequencies occurs. Baseband processing system 310 can be in communication with additional processors and other components that transmit and receive data via system 300. For example, system 300 can be incorporated as part of an AP that communicates with various UE. Baseband processing system 310 processes both signals received via antennas 110 and communications to be transmitted via antennas 110.

Transceiver 320, which is located between baseband processing system 310 and the RF (Radio Frequency) front end of system 300, manipulates both transmit and receive signals. Transceiver 320 can act as the intermediary between the digital processing domain of baseband processing system 310 and the analog domain of the RF signals. Transceiver 320 can be implemented as purpose-built hardware or as software executed on general-purpose hardware. Transceiver 320 can perform both up-conversion and down-conversion: during transmission, the transceiver up converts the baseband signal to a higher frequency RF signal suitable for transmission over antennas 110; and during reception, transceiver 320 converts the incoming RF signals to a lower frequency baseband signal that can be processed by baseband processing system 310. As part of or in addition to the frequency conversion functions, modulation and demodulation can be performed by transceiver 320.

The RF front end can include combiners/splitters 330; attenuators 340; and amplifiers 350. Via the RF front end, transceiver 320 and baseband processing system 310 is electrically connected with antennas 110. Combiners/splitters 330, which are referred to as “splitters 330” for simplicity herein, can be connected with transceiver 320. Therefore, each input/output of transceiver 320 is split into two inputs/outputs which are electrically connected with antennas 110.

Attenuators 340 are electronically-controlled, such as by baseband processing system 310 or some other processing system. The attenuation of attenuators 340 can be set to no attenuation, complete attenuation (i.e., block the signal), or some intermediary value (e.g., 3 dB). In some embodiments, four attenuators are present. Of the four antennas, two antennas may each be connected with two attenuators. As such, two antennas (e.g., antennas 110-3 and 110-4) are not electrically connected with attenuators and two antennas (e.g., antennas 110-1 and 110-2) are electrically connected with antennas. Each split input/output of transceiver 320 can have one branch connected with an attenuator of attenuators 340.

Amplifiers 350 may be electrically connected with each of splitters 330, and, for some input/outputs, attenuators 340. Amplifiers 350 can include low noise amplifiers (LNAs) that amplify received signals. An LNA is an electronic amplifier used to amplify weak signals, such as those received via antennas 110, while minimizing the amount of additional noise introduced to the signal. Amplifiers 350 can also include power amplifiers (PAS). A PA is an electronic amplifier designed to increase the power level of a signal. Power amplifiers are primarily concerned with boosting the strength of an already significant signal to a level suitable for driving a load, such as an antenna of antennas 110.

Amplifiers 350 can be connected, via microstrip feed with patch antennas 110. Antennas aligned along an axis can be electrically connected with the same splitters of splitters 330 and input/outputs of transceiver 320. For example, the feeds of patch antennas 110-1 and 110-3, which are aligned along a first axis, are both electrically connected with splitter 330-1 and splitter 330-2 via each antennas two feeds. Similarly, the feeds of patch antennas 110-2 and 110-4, which are aligned along a second axis orthogonal to the first axis within the azimuthal plane, are both electrically connected with splitter 330-3 and splitter 330-4 via each antennas two feeds.

Without attenuators 340 being present, it may be impossible or difficult for signal processing system 305 (or some other processing system) to ascertain the direction to a UE transmitting a signal due to ambiguity in which antenna along a given axis received the signal with greater signal strength. Referring to antennas 110-1 and 110-3, for example, when a signal is received by these antennas, the signals received by each antenna are combined together via splitters 330 making it impossible or extremely difficult to determine at which antenna a greater signal strength is present.

The use of attenuators 340 can resolve this issue. The signal strength received from antennas 110-1 and 110-2 can be temporarily attenuated to disambiguate a direction to a UE. When attenuating the signal received at one of the antennas aligned along an axis, a signal strength measurement can be made. If the signal strength drops significantly (e.g., by greater than 3 dB), a determination can be made that the antenna at which attenuation was performed is generally pointing toward the UE. If the signal strength does not drop significantly, a determination can be made that the antenna at which attenuation was performed is generally pointing away from the UE.

A UE can refer to any piece of electronic equipment that communicates wirelessly with system 300. A UE can be: a smartphone, a cellular phone, a cellular modem, a computer, an access point, an IoT device, a sensor device, or factory equipment.

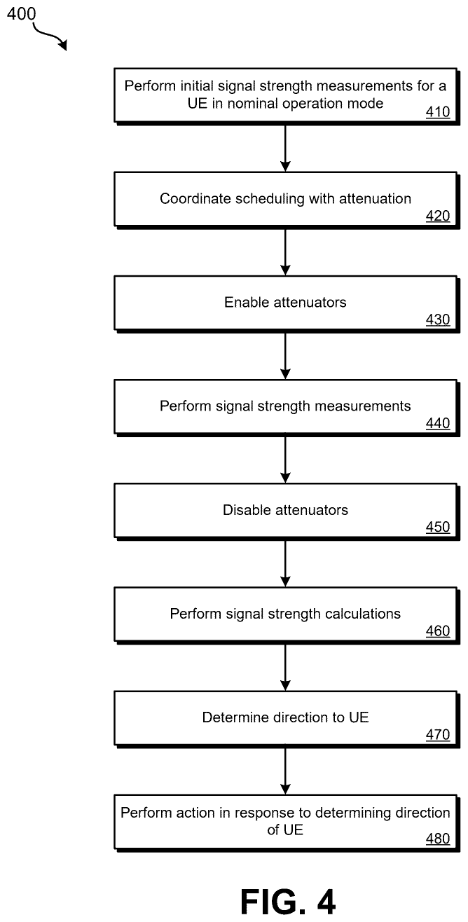

Various methods may be performed using the systems and antenna arrangements of FIGS. 1-3. FIG. 4 illustrates an embodiment of a method 400 for direction finding of a UE using an omni-directional antenna system. An embodiment of system 300 can be used to perform method 400.

At block 410, signal strength measurements on one or more signals received from a UE can be performed in a nominal operation mode. In the nominal operation mode, all attenuators are disabled and therefore no attenuation is applied to any received signal. These measurements can serve as a baseline for further analysis. As such, these signal strength measurements can be stored. For example, a signal strength measurement may be stored for each input to transceiver 320 or pair of antennas aligned along an axis. Referring to transceiver 320, the four input/outputs 325 may each have a signal strength indicated as RSRP_{1,i}, RSRP_{2,i}, RSRP_{3,i}, and RSRP_{4,i}, respectively. In this arrangement, each of these signal strength values do not correspond to a particular antenna because the received signals for antennas are mixed together. For example, RSRP_{2,i}, corresponding to input/output 325-2, is based on a combined signal from antenna 110-1 and antenna 110-3.

In some embodiments, before any attenuation is applied to disambiguate a direction to the UE, the timing of the attenuation is coordinated with scheduling at block 420. For example, if the omni-directional antenna system is being used for an indoor small cell that communicates using 5G NR, the distributed unit (DU) that managed scheduling may take into account when attenuation is to occur to avoid or minimize possible packet loss.

At block 430, one or more pairs of attenuators are activated. A pair of attenuators may be activated for a particular antenna. Alternatively, two pairs of attenuators may be activated for two particular antennas. One antenna along an axis is attenuated. If two antennas are attenuated, the attenuated antennas are arranged on orthogonal axes. The attenuators may completely block the reception of a signal or may introduce a predefined amount of attenuation, such as 3 dB or 6 dB.

At block 440, while attenuation is being applied to one or more antennas (e.g., two antennas in a four patch antenna array), additional signal strength measurements are made. In comparison with the signal strength measurements of block 410, these measurements provide data on how the signal strength varies when attenuation is applied to one antenna arrangement on an axis. Referring to transceiver 320, the four input/outputs 325 may each have a signal strength indicated as RSRP_{1,a} (for input 325-1), RSRP_{2,a} (for input 325-2), RSRP_{3,a} (for input 325-3), and RSRP_{4,a} (for input 325-4), respectively. Here, however, each of these signal strength values either correspond to a particular antenna or are weighted to correspond to a particular antenna due to the output of antennas 110-1 and 110-2 being attenuated. For example, RSRP_{2,a}, which corresponds to input/output 325-2, represents only the output of antenna 110-3 if the output of antenna 110-1 is fully attenuated.

Following block 440, if other antennas remain to be attenuated, blocks 430 and 440 may be repeated for antennas that have not yet been attenuated. Alternatively, if all antennas that have attenuators were attenuated at the same time, repetition may not be necessary.

Subsequently, at block 450, the attenuators are disabled to return to the nominal operation mode.

At block 460, calculations are performed using the signal strength measurements taken with and without attenuation to determine the direction to the UE. Such calculations can be performed in various orders.

First, Equation 1 can be calculated and, if true, indicates the UE is generally located along the east/west axis. In order for Equation 1 to be determined to be true, RSRP_{1,i}+RSRP_{2,i} may be required to be at least a predefined delta greater than RSRP_{3,i}+RSRP_{4,i}. If Equation 1 is true, Equation 2 is performed to determine whether the UE is east or west of the antenna array. If Equation 2 is determined to be true, the UE is generally east of the antenna array. If Equation 2 is determined to be false, the UE is generally west of the antenna array. For Equation 2, the two sides of the Equation do not need to match exactly but be within a predefined defined threshold of each other, such as 2 dB.

$${RSRP}_{1 , i} + {RSRP}_{2 , i} >> {RSRP}_{3 , i} + {RSRP}_{4 , i} \qquad Equation 1$$

$${RSRP}_{1 , i} + {RSRP}_{2 , i} = {RSRP}_{1 , a} + {RSRP}_{2 , a} \qquad Equation 2$$

If Equation 1 was false, then Equation 3 may be calculated. If true, Equation 3 indicates the UE is generally located along the north/south axis. In order for Equation 3 to be determined to be true, RSRP_{1,i}+RSRP_{2,i} may be required to be at least a predefined delta less than RSRP_{3,i}+RSRP_{4,i}. Equation 3 does not need to be calculated in addition to Equation 1, rather the result of Equation 1 can be used instead. If Equation 3 is true (i.e., if Equation 1 is false), Equation 4 is performed to determine whether the UE is north or south of the antenna array. If Equation 4 is determined to be true, the UE is generally north of the antenna array. If Equation 4 is determined to be false, the UE is generally south of the antenna array. For Equation 4, the two sides of the Equation do not need to match exactly but be within a predefined defined threshold of each other, such as 2 dB.

$${RSRP}_{1 , i} + {RSRP}_{2 , i} << {RSRP}_{3 , i} + {RSRP}_{4 , i} \qquad Equation 3$$

$${RSRP}_{3 , i} + {RSRP}_{4 , i} = {RSRP}_{3 , a} + {RSRP}_{4 , a} \qquad Equation 4$$

If, both Equation 1 and Equation 3 are false (e.g., within a defined delta or threshold), Equation 5 is determined to be true. The UE is generally in northeast, northwest, southeast, or southwest directions. In this case Equations 6-13 can be used to perform additional calculations to disambiguate the UE direction.

$${RSRP}_{1 , i} + {RSRP}_{2 , i} \approx {RSRP}_{3 , i} + {RSRP}_{4 , i} \qquad Equation 5$$

If Equations 6 and 7 are true within a threshold, the UE is determined to be in the northeast direction from the antenna array.

$${RSRP}_{1 , i} + {RSRP}_{2 , i} = {RSRP}_{1 , a} + {RSRP}_{2 , a} \qquad Equation 6$$

$${RSRP}_{3 , i} + {RSRP}_{4 , i} = {RSRP}_{3 , a} + {RSRP}_{4 , a} \qquad Equation 7$$

If Equations 8 and 9 are true within a threshold, the UE is determined to be in the northwest direction from the antenna array.

$${RSRP}_{1 , i} + {RSRP}_{2 , i} >> {RSRP}_{1 , a} + {RSRP}_{2 , a} \qquad Equation 8$$

$${RSRP}_{3 , i} + {RSRP}_{4 , i} = {RSRP}_{3 , a} + {RSRP}_{4 , a} \qquad Equation 9$$

If Equations 10 and 11 are true within a threshold, the UE is determined to be in the southeast direction from the antenna array.

$${RSRP}_{1 , i} + {RSRP}_{2 , i} = {RSRP}_{1 , a} + {RSRP}_{2 , a} \qquad Equation 10$$

$${RSRP}_{3 , i} + {RSRP}_{4 , i} >> {RSRP}_{3 , a} + {RSRP}_{4 , a} \qquad Equation 11$$

If Equations 12 and 13 are true within a threshold, the UE is determined to be in the southwest direction from the antenna array.

$${RSRP}_{1 , i} + {RSRP}_{2 , i} >> {RSRP}_{1 , a} + {RSRP}_{2 , a} \qquad Equation 12$$

$${RSRP}_{3 , i} + {RSRP}_{4 , i} >> {RSRP}_{3 , a} + {RSRP}_{4 , a} \qquad Equation 13$$

At block 470, the direction to the UE is determined based on using the calculations of block 460. In some embodiments, a general direction is determined, such as in 45° increments. In other embodiments, a more precise direction is attempted to be determined such as according to FIG. 4.

Finally, an action can be performed at block 480 in response to determining the direction to the UE. In some embodiments, since the direction to the UE is known, more power can be transmitted in the direction of the UE using one pair of antennas. For example, if the direction to many UEs communicating with the access point in which the antenna system is installed tend to be generally along the east/west axis, the amount of power output to the antennas along the north/south axis for transmitting signals may be decreased (and/or the power to the antennas for transmitting along the east/west axis may be increased).

Additionally or alternatively, the direction to the UE may be stored. The directional data may be stored in combination with a timestamp and may be used to create a heatmap showing where UE are located when they are communicating with the antenna system. Such information may be useful to a network administrator to determine how access points should be deployed to best serve the UE or how UE should be redistributed.

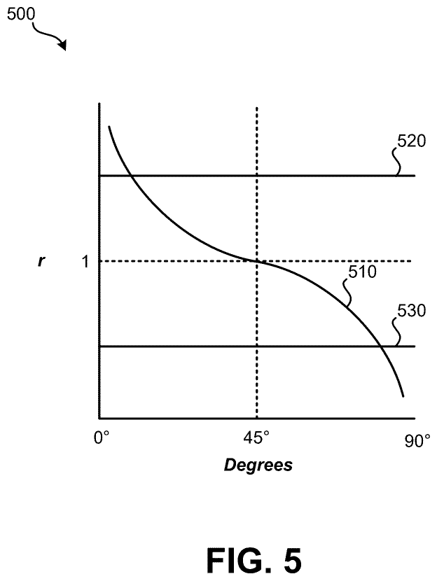

FIG. 5 illustrates an embodiment of a chart 500 indicative of how angular resolution can be increased to more precisely determine a direction to a UE. A reference curve 510 for a given quadrant can be pre-constructed, either based on the antenna pattern or actual measurements of signal strength at various angles. To perform such measurements, a UE can be placed at 0 degree and the reference signal received power (RSRP) can be measured. This process can then be repeated with x degrees of increment until 90 degrees is reached. The calculation can alternatively be based on an antenna gain pattern and corrected for the non-ideal real-world environment.

Equations 6 through 13 can be used to determine which quadrant a UE is locked in. Equation 14 can be used to determine whether the UE is located is first/fourth quadrant or the second/third quadrants.

$${RSRP}_{3 , i} + {RSRP}_{4 , i} > {RSRP}_{3 , a} + {RSRP}_{4 , a} \qquad Equation 14$$

If Equation 14 is determined to be true, the UE is located in the first/fourth quadrants, if not the second/third quadrants. The result of Equation 14 is used in combination with the earlier determinations of east and west to determine which specific quadrant the UE is located in.

For a given quadrant, a value of r can be calculated according to Equation 15. As illustrated, chart 500 shows the angle between north (0°) and east (90°). The value of r on curve 510 can be used to determine the angle of the direction to the UE. The specific values of curve 510 can vary by embodiment of the antenna array. In some embodiments, various thresholds, such as threshold value 520 and threshold value 530 are used to more generally determine the direction to the UE, such as 0°, 45°, or 90°.

$$r = \frac{{RSRP}_{3 , i} + {RSRP}_{4 , i}}{{RSRP}_{1 , i} + {RSRP}_{2 , i}} \qquad Equation 15$$

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. An omni-directional antenna system, comprising:
a first plurality of antennas and a second plurality of antennas, wherein the first plurality of antennas and the second plurality of antennas are arranged to create an omni-directional antenna beam pattern in the azimuthal plane;
a plurality of attenuators, wherein:
only a first subset of the first plurality of antennas is electrically connected with the plurality of attenuators; and
only a second subset of the second plurality of antennas is electrically connected with the plurality of attenuators; and
a signal processing system electrically connected with the first plurality of antennas, the second plurality of antennas, and the plurality of attenuators, wherein the signal processing system is configured to:
perform a first set of signal strength measurements with the plurality of attenuators disabled;
perform a second set of signal strength measurements with one or more of the attenuators enabled; and
determine a direction to a user equipment (UE) based on the first set of signal strength measurements and the second set of signal strength measurements.

2. The omni-directional antenna system of claim 1, wherein:
the first plurality of antennas comprises two antennas and the second plurality of antennas comprises two antennas; and
the plurality of attenuators comprises four attenuators, wherein two attenuators are connected with one antenna of the first plurality of antennas and another two attenuators are connected with one antenna of the second plurality of antennas.

3. The omni-directional antenna system of claim 2, further comprising, for each antenna of the first plurality of antennas and the second plurality of antennas, a plurality of feeds that allow for transmission and reception of multiple signal polarizations.

4. The omni-directional antenna system of claim 2, wherein the direction to the UE is determined based on whether a defined threshold attenuation in signal strength from the UE being detected when the one or more attenuators are enabled.

5. The omni-directional antenna system of claim 2, wherein each antenna of the first plurality of antennas and the second plurality of antennas is a patch antenna.

6. The omni-directional antenna system of claim 5, the first plurality of antennas and the second plurality of antennas are configured to communicate using orthogonal polarizations.

7. The omni-directional antenna system of claim 1, wherein the omni-directional antenna system is incorporated as part of an indoor wireless network access point such that the first plurality of antennas are arranged on a first axis and the second plurality of antennas are arranged on a second axis orthogonal to the first axis.

8. The omni-directional antenna system of claim 7, wherein the signal processing system is further configured to perform 5G New Radio (NR) communications with the UE.

9. The omni-directional antenna system of claim 1, wherein the omni-directional antenna beam pattern in the azimuthal plane includes a maximum difference of −6 dB between maximum and minimum antenna system gain.

10. The omni-directional antenna system of claim 1, wherein the signal processing system is further configured to increase transmitted signal strength in the determined direction of the UE and decrease the transmitted signal strength in a second direction distinct from the determined direction of the UE.

11. The omni-directional antenna system of claim 1, wherein the signal processing system is further configured to store an indication of a direction of the UE and a corresponding timestamp for when the direction was determined.

12. A method for direction finding using an omni-directional antenna system, the method comprising:
performing a first set of signal strength measurements with a plurality of attenuators disabled, wherein:
the omni-directional antenna system comprises a first plurality of antennas and a second plurality of antennas;
the first plurality of antennas and the second plurality of antennas are arranged to create an omni-directional antenna beam pattern in the azimuthal plane;
only a first subset of the first plurality of antennas is electrically connected with the plurality of attenuators; and
only a second subset of the second plurality of antennas is electrically connected with the plurality of attenuators;
performing a second set of signal strength measurements with one or more of the attenuators enabled; and
determining, based on the first set of signal strength measurements and the second set of signal strength measurements, a direction to a user equipment (UE).

13. The method of claim 12, wherein:
the first plurality of antennas comprises two antennas and the second plurality of antennas comprises two antennas; and
the plurality of attenuators comprises four attenuators, wherein two attenuators are connected with one antenna of the first plurality of antennas and another two attenuators are connected with one antenna of the second plurality of antennas.

14. The method of claim 13, further comprising, for each antenna of the first plurality of antennas and the second plurality of antennas, a plurality of feeds that allow for transmission and reception of multiple signal polarizations.

15. The method of claim 13, wherein the direction to the UE is determined based on whether a defined threshold attenuation in signal strength from the UE is detected when the one or more attenuators are enabled.

16. The method of claim 13, the first plurality of antennas and the second plurality of antennas are configured to communicate using orthogonal polarizations.

17. The method of claim 12, wherein the omni-directional antenna system is incorporated as part of an indoor wireless network access point such that the first plurality of antennas is arranged on a first axis and the second plurality of antennas are arranged on a second axis orthogonal to the first axis.

18. The method of claim 17, wherein the signal processing system is further configured to perform 5G New Radio (NR) communications with the UE.

19. The method of claim 12, wherein the omni-directional antenna beam pattern in the azimuthal plane includes a maximum difference of −6 dB between maximum and minimum antenna system gain.

20. The method of claim 12, further comprising increasing transmitted signal strength in the determined direction of the UE and decrease the transmitted signal strength in a second direction distinct from the determined direction of the UE.
